(19) United States
(12) Patent Application Publication
(10) Pub. No.: US 2018/0011981 A1
(43) Pub. Date: Jan. 11, 2018

(54) QUANTUM-BASED MACHINE LEARNING FOR ONCOLOGY TREATMENT

(71) Applicant: THE REGENTS OF THE UNIVERSITY OF MICHIGAN, Ann Arbor, MI (US)

(72) Inventors: Issam El Naqa, Ann Arbor, MI (US); Randall Ten Haken, Ann Arbor, MI (US)

(21) Appl. No.: 15/641,431

(22) Filed: Jul. 5, 2017

Related U.S. Application Data
(60) Provisional application No. 62/358,357, filed on Jul. 5, 2016.

(51) Int. Cl. G06F 19/00; G06N 5/04; G06N 99/00

(52) U.S. Cl. CPC G06F 19/345; G06N 99/005; G06F 19/324; G06N 5/04; G06N 99/002

(57) ABSTRACT

A method and system may utilize a quantum information state analog to reinforcement learning techniques to determine whether to adapt a course of treatment for an oncology patient. A quantum-based reinforcement learning engine may represent a decision to adapt and a decision not to adapt the course of treatment for the oncology patient as quantum information states in a superposition. Each quantum information state has a corresponding amplitude indicative of the likelihood that the quantum information state has a higher expected clinical outcome for the oncology patient. Using a quantum search algorithm, the quantum-based reinforcement learning engine identifies amplitudes for each quantum information state in the superposition. The quantum-based reinforcement learning engine instructs a health care provider to adapt the course of treatment for the oncology patient when a likelihood corresponding to the decision to adapt state exceeds a likelihood threshold.

### CROSS-REFERENCE TO RELATED APPLICATIONS

This application claims priority to provisional U.S. Application Ser. No. 62/358,357, filed on Jul. 5, 2016, entitled “Quantum-Based Machine Learning for Oncology Treatment,” the entire disclosure of which is hereby expressly incorporated by reference herein.

### TECHNICAL FIELD

The present disclosure generally relates to methods for using quantum-based machine learning techniques in oncology treatment and, more particularly, to determining whether to adapt a patient's oncology treatment upon receiving updated results of the current course of treatment on the patient.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Today, statistical methods generated from big data analysis may be used to predict outcomes in oncology regimens. These statistical methods may also be used to alter the oncology regimens based on information received during the treatment course to produce better quality of life and outcomes for the patient.

However, classical statistical methods are computationally inept and as the amount of big data increases, the methods become inefficient. Moreover, classical statistical methods may handle uncertainty ineffectively, for example as illustrated by the two-stage gambling game and the prisoner's dilemma, which violate the sure-thing principle. The sure-thing principle states that if a decision maker would perform a certain action under state of the world X, and the decision maker would perform the same action under complimentary state of the world ˜X, then s/he should perform the action when the state is unknown.

### SUMMARY

To decrease the computational cost of predicting outcomes and altering treatments in oncology regimens, a quantum-based machine learning system uses quantum information theory to design and adjust a course of treatment for a patient. For example, using quantum-inspired properties of superposition and parallelism, the quantum-based reinforcement learning system may significantly reduce the computational cost when compared to classical statistical methods. Moreover, quantum principles such as interference and contextuality allow the quantum-based reinforcement system to handle uncertainty better than the classical statistical methods, where the classical law of total probability is violated in the real world. Decision making processes are more accurately represented using the quantum principles of superposition, contextuality, and interference. For example, using classical statistical methods for determining an oncology regimen, a limited number of patient variables may be practically obtained for a patient, such as clinical data, physical data, biological data, laboratory data, etc. for the patient. Moreover, health care providers may only run tests on the patient a limited number of times, which leads to further uncertainty in the patient's data. While classical statistical methods typically generate a statistical model based on training data from several previous patients where the outcomes of the oncology regimens are known, it is difficult to compare the patient's data to the statistical model when the amount of data for the patient is missing information or incomplete.

More specifically, the quantum-based reinforcement learning system receives several patient variables for a cancer patient including clinical data, physical data, biological data, dosimetric data, etc. The system may also receive an indication of the severity of the cancer patient's tumor, such as a complication-free tumor control metric (P⁺), which may be a product of the tumor control probability (TCP), and the normal tissue complications probability (NTCP), where P⁺=TCP*(1−NTCP). TCP is a measure of a probability that a tumor has been eradicated or controlled for a particular dose based on the cells of the tumor. For example, TCP may be estimated using a Poisson model with volume as a tumor dose modifying factor. NTCP is a measure of a probability that a particular dose will cause an organ or structure to experience complications based on the cells of the organ or structure. For example, when the organ is a patient's liver, NTCP may be measured as a one-grade change in Albumin-Bilirubin (ALBI) toxicity score indicative of liver function using a Lyman-Kutcher-Berman (LKB) model.

Based on the patient variables and the severity of the cancer patient's tumor, the system may determine an optimal course of treatment for the patient using a predictive model generated using training data. After the patient receives the course of treatment for a predetermined period of time (e.g., one month), the system obtains another indication of the severity of the cancer patient's tumor as well as the updated patient variables. The system then determines whether the course of treatment appears to be working based on the second indication of the severity of the patient's tumor and the patient variables, and decides on adaptation or choosing alternative courses.

In some embodiments, the predictive model for predicting the outcomes of various courses of treatment based on the patient's clinical data, physical data, biological data, etc. and tumor severity may be generated using quantum machine learning. For example, each patient variable in the training set may be represented as a superposition of quantum information states, where the quantum information states have associated probabilities. The predictive model may then be generated using a quantum analog to classical machine learning techniques, such as support vector machines, Bayesian networks, etc.

To determine whether or not to adapt the course of treatment by for example, selecting a different fraction dose, the quantum-based reinforcement learning system represents the action state to adapt and the action state not to adapt as quantum states (qubits). A qubit (|ψₐ>) may include a superposition of the action states to adapt (|A>) or not to adapt (|Ã>), represented as |ψₐ>=a|Ã>+β|A>, where amplitudes α and β are complex numbers associated with the wave-like superposition. Amplitudes α and β also may be indicative of probabilities that the decision not to adapt or to adapt will maximize reduction in the severity of the patient's tumor. A quantum analog to a classical reinforcement learning technique, such as Grover's search algorithm may be used to determine whether to adapt or not to adapt.

In this manner, computational cost is reduced when using the quantum methods, because quantum operations can act on both action states simultaneously for a wave-like superposition. By contrast, classical statistical methods require separate computations on each action state (e.g., the decision to adapt and the decision not to adapt) to determine which one is more likely to maximize reduction in the severity of the patient's tumor. For example, Grover's search algorithm results in quadratic speedup in the computational cost when compared to classical search algorithms, because Grover's search algorithm is evaluated in O(√N) computations, where N is the number of items for the search. By contrast, a classical search algorithm requires O(N) computations, because the algorithm in the worst case may have to search through all N items.

In one embodiment, a computer-implemented method for adapting oncology treatment using quantum-based reinforcement learning is provided. The method includes receiving a first set of patient data for an oncology patient including a plurality of patient variables collected at a first time, determining a course of treatment for the oncology patient based on the first set of patient data, and generating a quantum adaptation model for determining whether to adapt the course of treatment, including representing a decision to adapt and a decision not to adapt the course of treatment as a superposition of quantum information states, wherein the decisions to adapt and not to adapt have associated likelihoods of improving a future clinical outcome for the oncology patient. The method further includes receiving an updated set of patient data for the oncology patient collected at a subsequent point in time after the first time, including at least some of the plurality of patient variables or including an indication of a current clinical outcome of the course of treatment, applying the updated set of patient data to the quantum adaptation model to determine a likelihood that the decision to adapt improves the future clinical outcome, and when the likelihood corresponding to the decision to adapt exceeds a threshold likelihood, transmitting an indication to a network-enabled device of a health care provider to administer an adapted course of treatment to the oncology patient.

In another embodiment, a computing device for adapting oncology treatment using quantum-based reinforcement learning is provided. The computing device includes a communication network, one or more processors and a non-transitory computer-readable memory coupled to the communication network and the one or more processors and storing instructions thereon. When executed by the one or more processors, the instructions cause the computing device to receive, via the communication network, a first set of patient data for an oncology patient including a plurality of patient variables collected at a first time, determine a course of treatment for the oncology patient based on the first set of patient data, and generate a quantum adaptation model for determining whether to adapt the course of treatment, including representing a decision to adapt and a decision not to adapt the course of treatment as a superposition of quantum information states, wherein the decisions to adapt and not to adapt have associated likelihoods of improving a future clinical outcome for the oncology patient. The instructions further cause the computing device to receive, via the communication network, an updated set of patient data for the oncology patient collected at a subsequent point in time after the first time, including at least some of the plurality of patient variables or including an indication of a current clinical outcome of the course of treatment, apply the updated set of patient data to the quantum adaptation model to determine a likelihood that the decision to adapt improves the future clinical outcome, and when the likelihood corresponding to the decision to adapt exceeds a threshold likelihood, transmit, via the communication network, an indication to a network-enabled device of a health care provider to administer an adapted course of treatment to the oncology patient.

### BRIEF DESCRIPTION OF THE DRAWINGS

FIG. 1A illustrates a block diagram of a computer network and system on which an exemplary quantum-based reinforcement learning system may operate in accordance with the presently described embodiments;

FIG. 1B illustrates a block diagram of an exemplary oncology treatment assessment server that can operate in the system of FIG. 1A in accordance with the presently described embodiments;

FIG. 2 illustrates a block diagram of an example quantum-based reinforcement learning feedback loop in accordance with the presently described embodiments;

FIG. 3 illustrates example results comparing classical adaptation decisions with quantum adaptation decisions in accordance with the presently described embodiments;

FIG. 4 illustrates example results comparing probability amplitudes and phases for quantum adaptation decisions in accordance with the presently described embodiments; and

FIG. 5 illustrates a flow diagram of an example method for adapting oncology treatment using quantum-based reinforcement learning techniques.

### DETAILED DESCRIPTION

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘_{———}’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. §112(f).

Generally speaking, techniques for adapting oncology treatments may be implemented in one or more network-enabled devices, one or more network servers, or a system that includes a combination of these devices. However, for example purposes, the examples below focus primarily on an embodiment in which an oncology treatment assessment server obtains a set of training data. In some embodiments, the training data may be obtained from a network-enabled device. The oncology treatment assessment server may classify patient variables within the set of training data according to the dose the patient received and/or the results of the treatment as indicated by the severity of the patient's tumor. The oncology treatment assessment server may then be trained using the patient variables via a quantum analog of a classical machine learning technique, such as support vector machines, Bayesian networks, etc. to generate a quantum model. The quantum model may be used to predict the outcome of various oncology treatments (e.g., dosages) for a patient based on the patient's clinical data, biological data, physical data, etc.

After the oncology treatment assessment server has been trained, patient data may be collected for an oncology patient at a first point in time and compared to the quantum model to determine an optimal oncology treatment for the patient having the best expected clinical outcome. The patient data may include several patient characteristics, such as clinical variables, laboratory variables, biopsy variables, physical variables, biological variables, dosimetric variables, an indication of the severity of the patient's tumor, etc. An indication of the optimal oncology treatment may be transmitted to a health care provider's network-enabled device for the health care provider to administer the optimal oncology treatment.

Additionally, the oncology treatment assessment server may generate a quantum adaptation model for determining whether to adapt the course of treatment over time (e.g., adjust the dosage) via a quantum analog to a classical reinforcement learning technique, such as Markov Decision Processes (MDP). At a subsequent point in time, the oncology treatment assessment server may collect patient data once again after the patient has received the oncology treatment, including the results of the treatment as indicated by the severity of the patient's tumor. Using the quantum adaptation model and the patient data collected at the subsequent point in time, the oncology treatment assessment server may determine whether or not to adapt the course of treatment. An indication of whether or not to adapt the oncology treatment may be transmitted to a health care provider's network-enabled device for the health care provider to administer the adapted or previous oncology treatment.

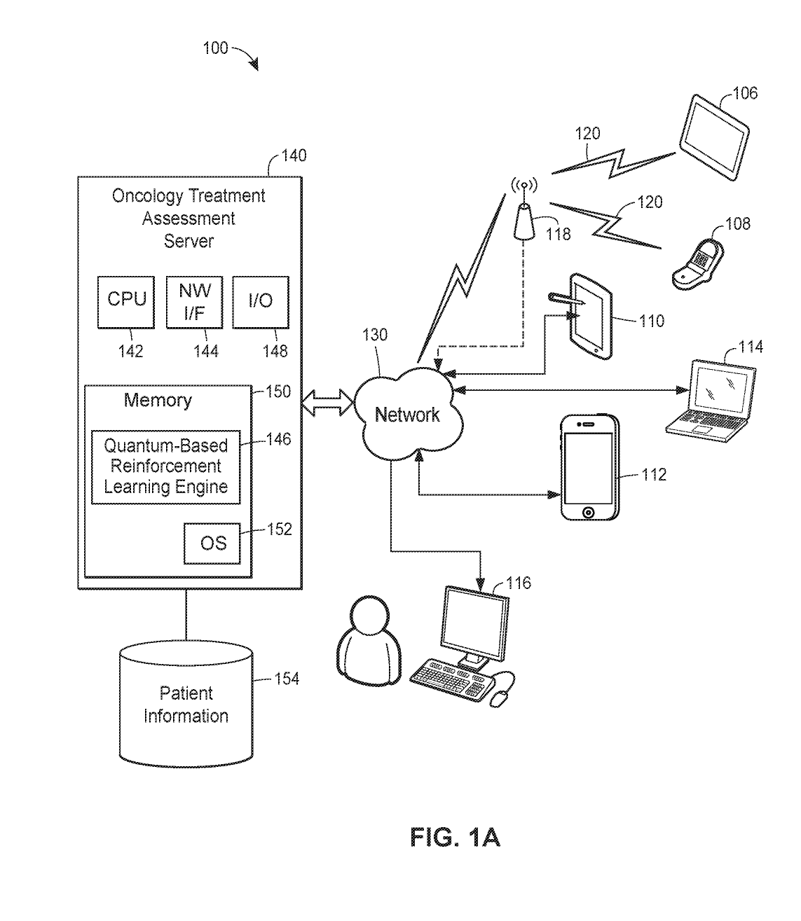

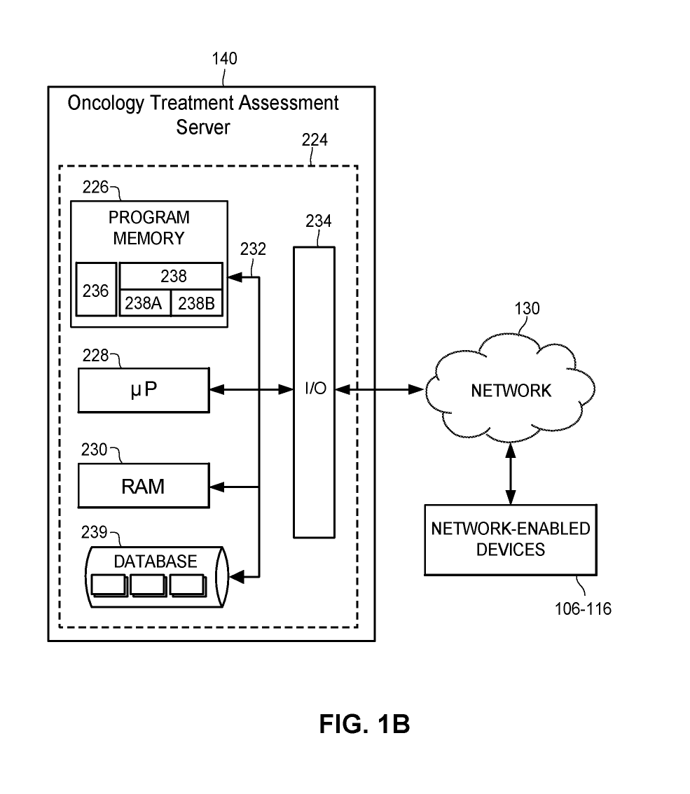

Referring to FIG. 1A, an example quantum-based reinforcement learning system 100 includes an oncology treatment assessment server 140 and a plurality of network-enabled devices 106-116 which may be communicatively connected through a network 130, as described below. In an embodiment, the oncology treatment assessment server 140 and the network-enabled devices 106-116 may communicate via wireless signals 120 over a digital network 130, which can be any suitable local or wide area network(s) including a Wi-Fi network, a Bluetooth network, a cellular network such as 3G, 4G, Long-Term Evolution (LTE), the Internet, etc. In some instances, the network-enabled devices 106-116 may communicate with the digital network 130 via an intervening wireless or wired device 118, which may be a wireless router, a wireless repeater, a base transceiver station of a mobile telephony provider, etc.

The network-enabled devices 106-116 may include, by way of example, a tablet computer 106, a network-enabled cell phone 108, a personal digital assistant (PDA) 110, a mobile device smart-phone 112 also referred to herein as a “mobile device,” a laptop computer 114, a desktop computer 116, a portable media player (not shown), a wearable computing device such as Google Glass™ (not shown), a smart watch, a phablet, any device configured for wired or wireless RF (Radio Frequency) communication, etc. Moreover, any other suitable network-enabled device that records clinical variables, physical variables, biological variables, laboratory variables, biopsy variables, dosimetric variables, or the severity of a patient's tumor for patients may also communicate with the oncology treatment assessment server 140.

Each of the network-enabled devices 106-116 may interact with the oncology treatment assessment server 140 to transmit the clinical variables, physical variables, biological variables, laboratory variables, biopsy variables, dosimetric variables, or the severity of a patient's tumor which may be collected at a first point in time (before administering an oncology treatment to the patient and at one or more follow up visits (for determining whether or not to adapt the treatment).

Each network-enabled device 106-116 may also interact with the oncology treatment assessment server 140 to receive an indication of a course of treatment to administer to a patient and/or an indication of whether or not to adapt the course of treatment. For example, the network-enabled device 106-116 may receive instructions to administer a particular dose, fraction size, etc.

In an example implementation, the oncology treatment assessment server 140 may be a cloud based server, an application server, a web server, etc., and includes a memory 150, one or more processors (CPU) 142 such as a microprocessor coupled to the memory 150, a network interface unit 144, and an I/O module 148 which may be a keyboard or a touchscreen, for example. While the oncology treatment assessment server 140 is described as a classical computing device, the oncology treatment assessment server 140 may also be a quantum computing device including any suitable systems governed by quantum-mechanical principles and capable of performing operations on data or input based on those quantum-mechanical principles. The quantum computing device may represent data or input via quantum-mechanical properties, such as spin, charge, polarization, optical properties, thermal properties, magnetic properties, etc., and, in some cases, the quantum computing device may include one or more qubits.

By way of example and without limitation, the quantum computing device may include: (i) an Ising spin glass in which data is represented by Ising spins; (ii) non-Abelian topologically ordered phases of matter in which data is represented by braiding of anyonic quasiparticles; (iii) three dimensional (3D) lattice cluster states in which data is represented by topologically protected quantum gates; (iv) superconducting systems in which data is represented by small superconducting circuits (e.g., Josephson junctions); (v) trapped atoms, ions, or molecules (e.g., trapped by electromagnetic fields or optical lattices) in which data is represented by two or more energy levels, such as hyperfine levels; (vi) one or more quantum dots (or quantum wells) in which data is represented by confined excitations; (vii) linear optical elements in which data in represented by optical modes of photons; or (viii) Bose-Einstein condensates in which data is represented by one or more energetically protected two-level states. It is understood, that any suitable quantum system may represent data or input via quantum-mechanical properties and perform operations on that data based on the quantum-mechanical properties.

Preparation or manipulation of the quantum computing device and obtaining of results from the quantum computing device may include measurements performed by corresponding input interfaces and corresponding output interfaces, in some implementations. For example, in a case in which the quantum computing device includes topologically ordered phases of matter (e.g., as in a topological quantum computer), the input interfaces and the output interfaces may include one or more interferometers to perform quasiparticle braiding, topological charge measurement, and/or other topologically transformative manipulations. Alternatively, in the case in which the quantum computing device includes superconducting systems, the input interfaces and the output interfaces may include various superconducting quantum interference devices (SQUIDs) to measure magnetic properties with high sensitivity. It is understood, however, that the input interfaces and the output interfaces may include any appropriate combination of hardware, classical computer processing, and/or software components configured to measure, manipulate, and/or otherwise interact with the quantum computing device.

While oncology treatment assessment server 140 may be a quantum computing device, the remaining description and Figures focus on an embodiment where the oncology treatment assessment server 140 is a classical computing device. References to quantum-based methods performed on the classical computing device simulate the effects of quantum mechanical properties (e.g., a superposition of states, entanglement, quantum tunneling, interference, contextuality, etc.). These simulations may be performed using mathematical models rather than measuring quantum-mechanical properties of particles.

In any event, the oncology treatment assessment server 140 may also be communicatively connected to a patient information database 154. The patient information database 154 may store the clinical variables, physical variables laboratory variables, biopsy variables, biological variables, dosimetric variables, and tumor severities collected at baseline or during one or more follow-up visits for each patient. In some embodiments, to determine whether or not to adapt a patient's oncology treatment, the oncology treatment assessment server 140 may retrieve patient information for each patient from the patient information database 154.

The memory 150 may be tangible, non-transitory memory and may include any types of suitable memory modules, including random access memory (RAM), read only memory (ROM), flash memory, other types of persistent memory, etc. The memory 150 may store, for example instructions executable of the processors 142 for an operating system (OS) 152 which may be any type of suitable operating system such as modern computing device operating systems, for example. The memory 150 may also store, for example instructions executable on the processors 142 for a quantum-based reinforcement learning engine 146. The oncology treatment assessment server 140 is described in more detail below with reference to FIG. 1B. In some embodiments, the quantum-based reinforcement learning engine 146 may be a part of one or more of the network-enabled devices 106-116 or a combination of the oncology treatment assessment server 140 and the network-enabled devices 106-116.

In any event, the quantum-based reinforcement learning engine 146 may receive electronic data from the network-enabled devices 106-116. For example, the quantum-based reinforcement learning engine 146 may obtain a set of training data by receiving clinical variables, laboratory variables, physical variables, biological variables, biopsy variables, and the severity of tumors for oncology patients. The training data may also include dosimetric variables indicating the treatment provided to the oncology patients. The patient variables may be received from health care providers, for example on a desktop computer 116 which may transmit the set of training data to the oncology treatment assessment server 140.

As a result, the quantum-based reinforcement learning module 146 may generate a quantum model for predicting outcomes of various courses of treatment via a quantum analog to a machine learning algorithm, such as support vector machines or Bayesian networks using the training data. For example, while a classical model may be generated using graph kernels which compute an inner product on graphs, the quantum analog computes an inner product on qubits used to represent a superposition of the state variables from the training data.

The quantum-based reinforcement learning engine 146 may then receive a set of patient data for an oncology patient. For example, a health care provider may input clinical, physical, laboratory, biological, and/or biopsy results collected at a first point in time and an indication of the severity of the patient's tumor on a desktop computer 116 which may be transmitted to the oncology assessment server 140. The quantum-based reinforcement learning engine 146 may then apply the patient data to the quantum model and may determine the optimal course of treatment for the patient. For example, quantum-based reinforcement learning engine 146 may use the quantum model to determine an expected reduction in the severity of the patient's tumor for each of several possible courses of treatment. The expected reduction may be a product of the probability of tumor reduction and the amount of tumor reduction associated with the probability. Then the course of treatment having the highest expected reduction in the severity of the patient's tumor may be selected and displayed on a user interface for a health care provider to administer the selected course of treatment.

Additionally, the quantum-based reinforcement learning engine 146 may generate a quantum adaptation model for determining whether or not to adapt the selected course of treatment via a quantum analog to a reinforcement learning algorithm, such as Markov Decision Processes (MDP). For example, a classical model may generate a function to maximize an expected reward (e.g., complication-free tumor control metric (P⁺)) for various states (e.g., patient variable values) by evaluating various policy decisions (e.g., to adapt or not to adapt), where the expected reward is discounted over time. The quantum model may represent the time evolution of the various states using a time-dependent Schrödinger wave equation:

|ψₐ(t)>=e^{-iHt/h}|ψₐ>,

were H is a Hamiltonian.

At a subsequent time (e.g., one month after first administering the course of treatment), the quantum-based reinforcement learning engine 146 may receive another set of patient data for the oncology patient. For example, the health care provider may input clinical, physical, laboratory, biological, and/or biopsy results collected at the subsequent point in time and an indication of the severity of the patient's tumor on a desktop computer 116 which may be transmitted to the oncology assessment server 140. In some embodiments, the health care provider may not be able to collect each type of data for the patient at the subsequent point in time and may only collect a subset of the data. Using the quantum adaptation model, the quantum-based reinforcement learning engine 146 may determine whether or not to adapt the treatment for the patient to adjust to a different dosage for example. Unlike a classical statistical model which may induce a belief state or probability distribution over unknown patient states, the quantum adaptation model uses a quantum state or superposition of states rather than a simple probability distribution. The quantum-based reinforcement learning engine 146 may then transmit an indication of whether or not to adapt the treatment to a network-enabled device 106-116 of the health care provider for the health care provider to adjust the treatment or continue with the original treatment.

The oncology treatment assessment server 140 may communicate with the network-enabled devices 106-116 via the network 130. The digital network 130 may be a proprietary network, a secure public Internet, a virtual private network and/or some other type of network, such as dedicated access lines, plain ordinary telephone lines, satellite links, combinations of these, etc. Where the digital network 130 comprises the Internet, data communication may take place over the digital network 130 via an Internet communication protocol.

Turning now to FIG. 1B, the oncology treatment assessment server 140 may include a controller 224. The controller 224 may include a program memory 226, a microcontroller or a microprocessor (MP) 228, a random-access memory (RAM) 230, and/or an input/output (I/O) circuit 234, all of which may be interconnected via an address/data bus 232. In some embodiments, the controller 224 may also include, or otherwise be communicatively connected to, a database 239 or other data storage mechanism (e.g., one or more hard disk drives, optical storage drives, solid state storage devices, etc.). The database 239 may include data such as patient information, training data, web page templates and/or web pages, and other data necessary to interact with users through the network 130. It should be appreciated that although FIG. 1B depicts only one microprocessor 228, the controller 224 may include multiple microprocessors 228. Similarly, the memory of the controller 224 may include multiple RAMs 230 and/or multiple program memories 226. Although FIG. 1B depicts the I/O circuit 234 as a single block, the I/O circuit 234 may include a number of different types of I/O circuits. The controller 224 may implement the RAM(s) 230 and/or the program memories 226 as semiconductor memories, magnetically readable memories, and/or optically readable memories, for example.

As shown in FIG. 1B, the program memory 226 and/or the RAM 230 may store various applications for execution by the microprocessor 228. For example, a user-interface application 236 may provide a user interface to the oncology treatment assessment server 140, which user interface may, for example, allow a system administrator to configure, troubleshoot, or test various aspects of the server's operation. A server application 238 may operate to receive a set of patient data for an oncology patient, determine whether to adapt a course of treatment for the patient, and transmit an indication of whether to adapt the treatment to a health care provider's network-enabled device 106-116. The server application 238 may be a single module 238, such as the quantum-based reinforcement learning engine 146 or a plurality of modules 238A, 238B.

While the server application 238 is depicted in FIG. 1B as including two modules, 238A and 238B, the server application 238 may include any number of modules accomplishing tasks related to implementation of the oncology treatment assessment server 140. Moreover, it will be appreciated that although only one oncology treatment assessment server 140 is depicted in FIG. 1B, multiple oncology treatment assessment servers 140 may be provided for the purpose of distributing server load, serving different web pages, etc. These multiple oncology treatment assessment servers 140 may include a web server, an entity-specific server (e.g. an Apple® server, etc.), a server that is disposed in a retail or proprietary network, etc.

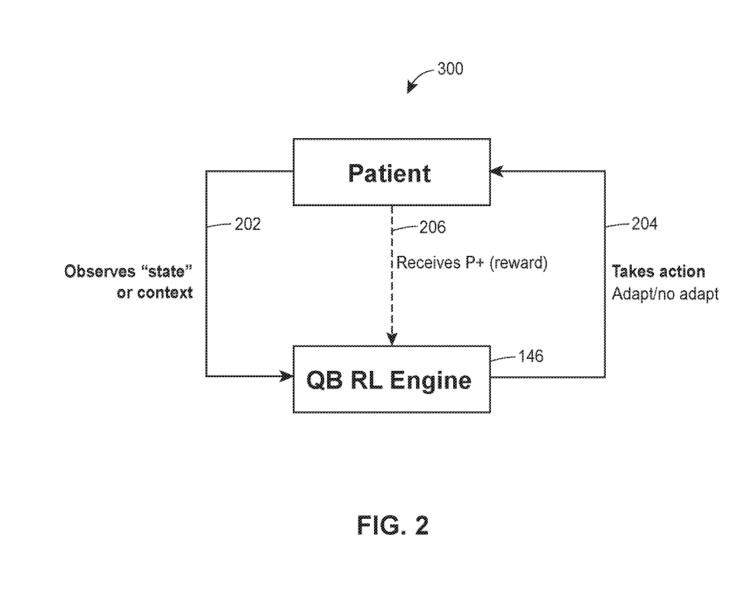

FIG. 2 illustrates a block diagram of a reinforcement learning feedback loop 300 which includes the quantum-based reinforcement learning engine 146 of FIG. 1. To perform reinforcement learning, the quantum-based reinforcement learning engine 146 obtains several state variables for the patient (patient variables). The state variables may be clinical variables, laboratory variables, biological variables, biopsy variables, dosimetric variables, etc. The clinical variables may include demographics, cancer stage, tumor volume, histology, co-morbidities, weight loss, etc. Dosimetric variables may include dose, fraction size, equivalent uniform does, adjusted dose-volume metrics, etc. Based on the state variables collected at a first point in time, the quantum-based reinforcement learning engine 146 may identify a course of treatment for the patient by comparing the state variables for the patient to a quantum model to determine an optimal oncology treatment for the patient having the best expected clinical outcome. In other embodiments, the patient may already be administered a course of treatment as indicated by the patient's dosimetric variables.

The quantum model for determining an optimal oncology treatment may be generated by using a quantum analog to classical machine learning techniques, such as support vector machines or Bayesian networks. For example, a classical model may be generated using graph kernels derived from tensor products for a set of training data which includes patient variables for several oncology patients, where a clinical outcome is known for each of the patients (e.g., a P+). The quantum model may be generated by determining:

$${K}_{g} ( x , x ’ ) = \frac{1}{trace ( {K}_{g} )} {\sum }_{i , j = 1}^{N} < {x}_{i} \vert {x}_{j} > {}^{d} ‖ {x}_{i} ‖ ‖ {x}_{j} ‖ \vert i > ⊗ \vert j > ,$$

where [symbol] is a tensor operator, d is the polynomial order for the kernels (e.g., linear type kernels, polynomial type kernels, etc.), x is an input variables vector, x′ is a training vector, and N is the number of training vectors.

K_{g}(x, x′) may provide an indication of the amount of similarity between the training vectors and the input variables vectors. K_{g}(x, x′) is then applied to a utility function (U) to determine the course of treatment having the maximum expected utility (e.g., P+). The utility function U may be represented as:

U(x)=Σᵢ₌₁^{N}^{ₛ}αᵢPᵢ⁺K_{g}(x,x′),

where Pᵢ+ is the clinical outcome for a training vector, Nₛ is the number of training vectors and a, are dual coefficients or weights. In some embodiments, the quantum model may be generated using a quantum search algorithm, such as Grover's search algorithm which may be result in a quadratic speedup when compared to classical methods, such as sequential minimal optimization (SMO), quadratic programming, or any other suitable dynamic programming method.

Using the quantum model and a set of state variables collected for a patient (patient variables), the quantum-based reinforcement learning engine 146 may identify an optimal course of treatment for the patient. For example, the quantum model may be used to identify a set of training data which is the most similar to the patient variables. Within the identified set of training data, the quantum-based reinforcement learning engine 146 may identify a subset of the set of training data which provided the best clinical outcome. Accordingly, the quantum-based reinforcement learning engine 146 may identify the optimal course of treatment based on the course of treatment (e.g., dosimetric variables) for the subset of the set of training data which provided the best clinical outcome and is most similar to the patient variables. In other embodiments, another quantum-based machine learning engine may be used to identify the optimal course of treatment using the quantum model.

In any event, at a second and any other subsequent point in time, the quantum-based reinforcement learning engine 146 obtains at least some of the state variables (block 202) for the patient. A reward (block 206) may also be obtained in the form of a complication-free tumor control metric (P⁺), which may be a product of a tumor control probability (TCP), and a normal tissue complications probability (NTCP) for the patient, where P⁺=TCP*(1−NTCP). In some embodiments TCP and NTCP may be weighted, such that P+=w₁*TCP+(1−w₂*NTCP), where w₁ and w₂ are respective weights. In some embodiments, the health care provider may select the respective weights, for example via one or more user controls on the health care provider's network-enabled device 106-116. While the reward is described as a complication-free tumor control metric (P+) throughout this specification, this is for ease of illustration only. The reward may be any suitable complication-free tumor control metric or may be any other suitable reward indicative of the health of the patient.

In any event, using the received reward and state variables, the quantum-based reinforcement learning engine 146 may identify an action or policy (block 204) which will maximize the total expected reward (P+) for the patient. The total expected reward may be discounted over time. In some embodiments, the action or policy may be a decision to adapt the treatment to a different set of dosimetric variables or continue to provide the same treatment to the patient.

The decision to adapt the treatment or continue to provide the same treatment to the patient may be represented by a qubit, |ψₐ>=α|A>+β|A>, where |A> is the action state to adapt the treatment, |Ã> is the action state not to adapt the treatment, and amplitudes α and β are complex numbers associated with the wave-like superposition. Amplitudes α and β also may be indicative of probabilities that the decision not to adapt or to adapt will increase the reward (P+) or provide the best expected reward. For example, probability may be calculated as a square of the magnitude of the amplitude, |α|² and |β|². The amplitudes α and β may be determined according to the state variables and the reward received at the current point in time. For example, based on the state variables alone, training data may indicate that the current course of treatment is unlikely to increase the reward (P+). However, when the reward is above a certain threshold, the quantum-based reinforcement learning engine 146 may determine that the state variables in combination with the received reward indicate that the current course of treatment is more likely to increase the reward (P+) than others courses of treatment.

The quantum-based reinforcement learning engine 146 may identify a particular policy (it) (e.g., to adapt or not to adapt) to maximize the expected reward discounted over time (V) at a particular state (s) (e.g., a combination of state variables). This policy may be identified using the following equation:

V^{π}(s)=E{R|s,π},

where R is a return function.

The return function (R) may be determined based on individual expected rewards for each state (s) which are discounted over time. Using the qubit (|ψₐ>), the expected reward may be calculated over time by applying the time-dependent Schrödinger wave equation to the qubit which may be calculated as:

|ψₐ(t)>=e^{-iHt/h}|ψₐ>,

were H is a Hamiltonian. The Hamiltonian may be identified using quantum annealing and/or quantum adiabatic approaches. By using quantum annealing, the quantum-based machine learning engine 146 may escape local minima in the return function via quantum tunneling. By escaping local minima, the expected reward for a given point in time may be greater than 1 or less than 0 which is not possible in the classical world.

The resulting qubit at each point in time may be combined with the expected reward (P+) for the subsequent point in time, resulting in the following equation:

R=Σₜ₌₀^{∞}Pₜ₊₁⁺e^{-iHt/h}|ψₐ>,

where Pₜ₊₁⁺ is an expected reward for the subsequent point in time which may be different for the decision to adapt state (|A>) than the decision not to adapt state (|Ã>).

As opposed to classical statistical methods, where each policy is evaluated individually to identify the policy which maximizes the expected discounted reward (V), the quantum-based approach allows the quantum-based reinforcement learning engine to evaluate multiple policies (|A> and |Ã>) at once using a single qubit. To identify the policy which maximizes the expected discounted reward, the quantum-based reinforcement learning engine 146 utilizes a quantum search algorithm, such as Grover's quantum search algorithm.

In some embodiments, when the state of the system is unknown (e.g., at least some of the combination of state variables are unknown, such as the patient's tumor volume, weight loss, etc.), the quantum-based reinforcement learning engine uses a quantum analogue to a partially observable Markov decision process (POMDP). In a classical POMDP, a state is modeled as a belief state (b′) which is a probability distribution over possible states. The quantum analog of the probability distribution is a superposition of all possible states or qubit as opposed to a probability distribution. For example, if there are five possible states corresponding to the patient's state variables which are categorized as very healthy, healthy, moderate health, not healthy, very unhealthy, the qubit may be modeled as (|ψ>)=α|ψ₁>+β|ψ₂>+γ|ψ₃>+δ|ψ₄>+ε|ψ₅>. Each possible state may also have corresponding action states which may be modeled by the qubit, |ψₐ> as mentioned above.

In any event, the quantum-based reinforcement learning engine 146 may identify a particular policy (π) (e.g., to adapt or not to adapt) to maximize the expected reward discounted over time (V) at a particular state of the superposition of states. This policy may be identified using the following equation:

V^{π}(ρ)=E{R|ρ,π},

where R=trace(Σₜ₌₀^{∞} Pₜ₊₁⁺ρ) and ρ is a density matrix for pure states of the outer product |ψ><ψ|.

In this manner, the quantum-based reinforcement learning engine 146 may identify a particular policy (π) even when the state of the system is unknown. Because quantum methods handle uncertainty better than classical methods, the quantum-based reinforcement learning engine 146 can more accurately determine whether or not to adapt the treatment when at least some of the patient variables are unknown. This is because quantum probability includes contextuality meaning that the context is which a measurement is made on a quantum state (a qubit) affects the results of the measurement. For example, the order in which qubits are measured will affect the outcome of the measurement. This is similar to human decision making processes where previous results may affect a person's future decisions and differs from classical probability which is context neutral.

In an exemplary scenario, clinical trials may be conducted on patients using the above-mentioned techniques. For example, a first group of patients may receive an experimental treatment while a second group of patients may receive a placebo. Patient data may be collected for each patient in the first and seconds groups of patients, such as clinical, physical, laboratory, biological, and/or biopsy results and an indication of the severity of the patient's tumor. After a threshold amount of time (e.g., one week, one month, one year, etc.), an updated set of patient data may be retrieved for each patient in the first and second groups of patients, including the results of the experimental treatment or placebo for each patient as indicated by the severity of the patient's tumor. Using the quantum adaptation model and the updated set of patient data for a patient in the first group, the oncology treatment assessment server 140 may determine whether or not to adapt the experimental treatment for the patient to adjust to a different dosage, for example. Then, an indication of whether or not to adapt the experimental treatment may be transmitted to a health care provider's network-enabled device for the health care provider to administer the adapted or previous experimental treatment.

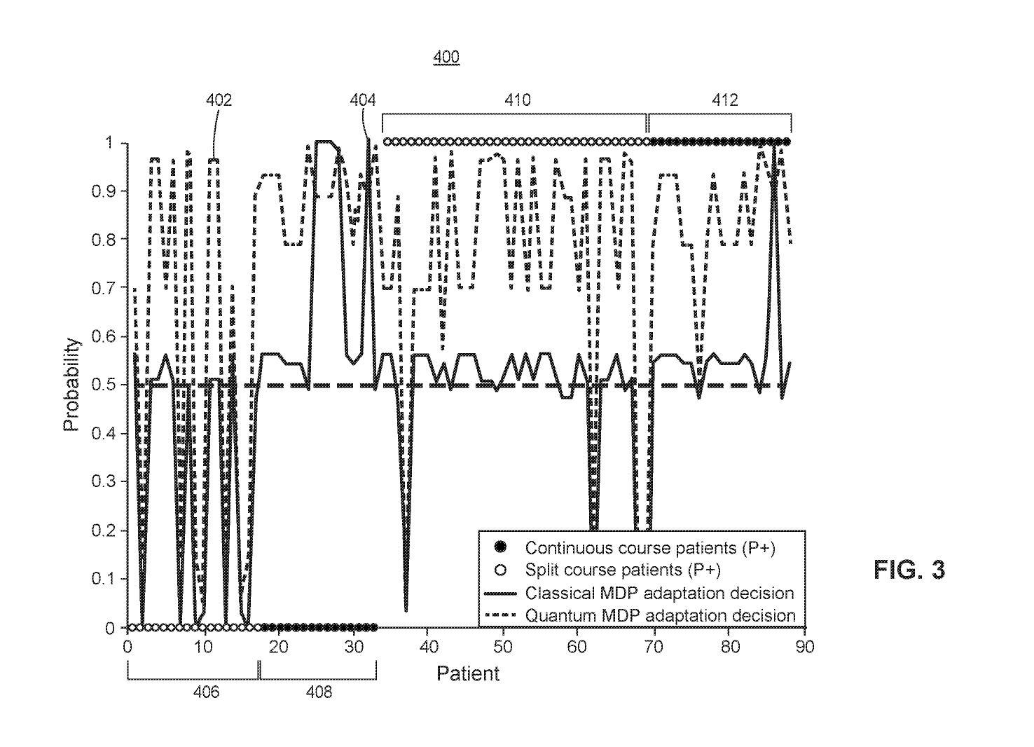

FIG. 3 illustrates example results 400 having probability amplitudes 402 for determining whether or not to adapt an oncology patient's treatment by changing to a split-course, adding fractions, or otherwise changing the dosage after the initial course using a quantum adaptation model via the quantum-based reinforcement learning engine 146. This is compared to probability amplitudes 404 using a classical adaptation model, such as reinforcement learning. Each probability amplitude may indicate a probability that a corresponding patient's treatment should be adapted. Probabilities at or above 0.5 may be indicative of adaptation, whereas probabilities below 0.5 may indicate that the treatment should stay the same. Patients represented by open circles 406, 410 received split-courses of treatment, whereas patients represented by closed circles 408, 412 received continuous courses of treatment. Additionally, patients 1-33 (references nos. 406, 408) had low complication-free tumor control metrics (P+<0.5) and patients 34-88 (references nos. 410, 402) had high complication-free tumor control metrics (P+>0.5).

Both adaptation models suggest adaptation (an average at or above 0.5) 79 percent of the time for split-course patients 406, 410 and 100 percent of the time for continuous course patients 408, 412. However, the classical adaptation model has an average probability amplitude of 0.59±0.16 while the quantum adaptation model has an average probability amplitude of 0.76±0.28. Also in cases where split-course patients had low complication-free tumor control metrics (patients 1-17), the classical adaptation model has an average probability amplitude of 0.31±0.26, whereas the quantum adaptation model has an average probability amplitude of 0.57±0.4. Thus, the quantum adaptation model suggests adaptation with higher confidence even when adaptation failed (P+<0.5) in patients 1-17.

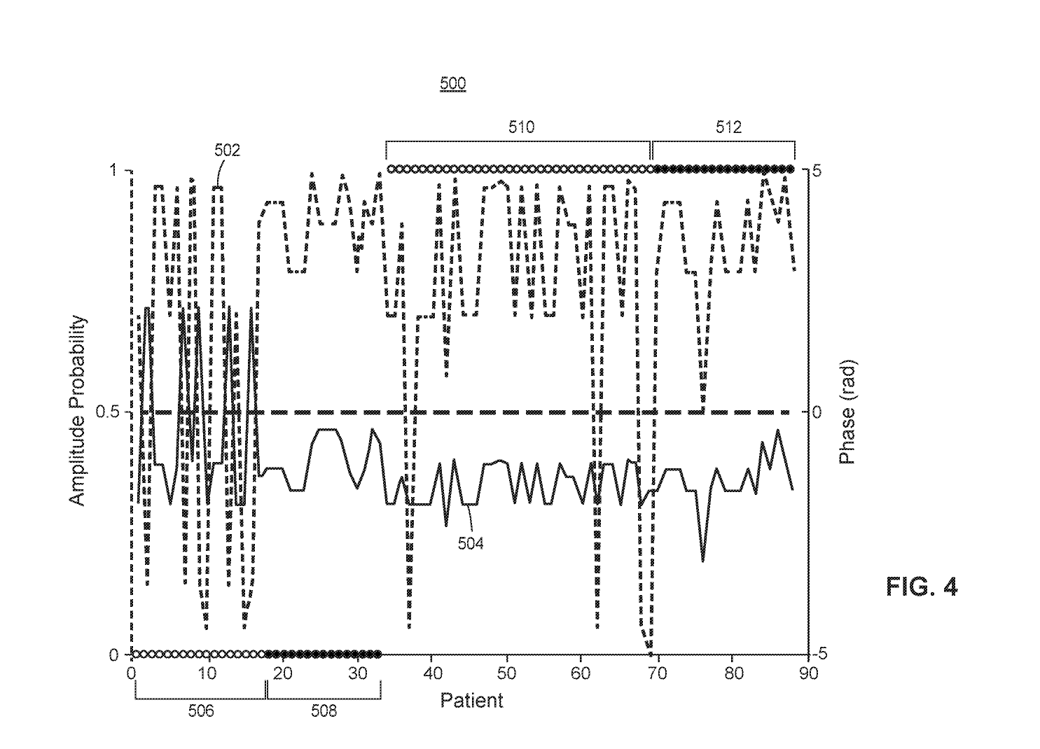

FIG. 4 illustrates example results 500 having the same probability amplitudes 502 for determining whether or not to adapt an oncology patient's treatment using a quantum adaptation model via the quantum-based reinforcement learning engine 146, as in FIG. 4. The example results 500 also include phase factors 504 corresponding to each of the probability amplitudes. The phase factors 504 may be the relative difference in phase between for the decision to adapt state (|A>) and the decision not to adapt state (|Ã>) for the qubit which represents the decision to adapt the treatment or continue to provide the same treatment for the patient (|ψₐ>=α|Ã>+β|A>). In some embodiments, the phase factor for a patient may be determined based on a difference in phase between α and β. Additionally, the probability amplitude for the patient may be determined as the magnitude squared of the amplitude for the decision to adapt state (|β|²).

As shown in FIG. 4, there are higher fluctuations in the phase factor for patients 1-33 (references nos. 506, 508) having low complication-free tumor control metrics (P+<0.5) compared to the phase factor for patients 34-88 (references nos. 510, 512) having high complication-free tumor control metrics (P+>0.5). This may indicate higher interference or instability in decision making in such scenarios.

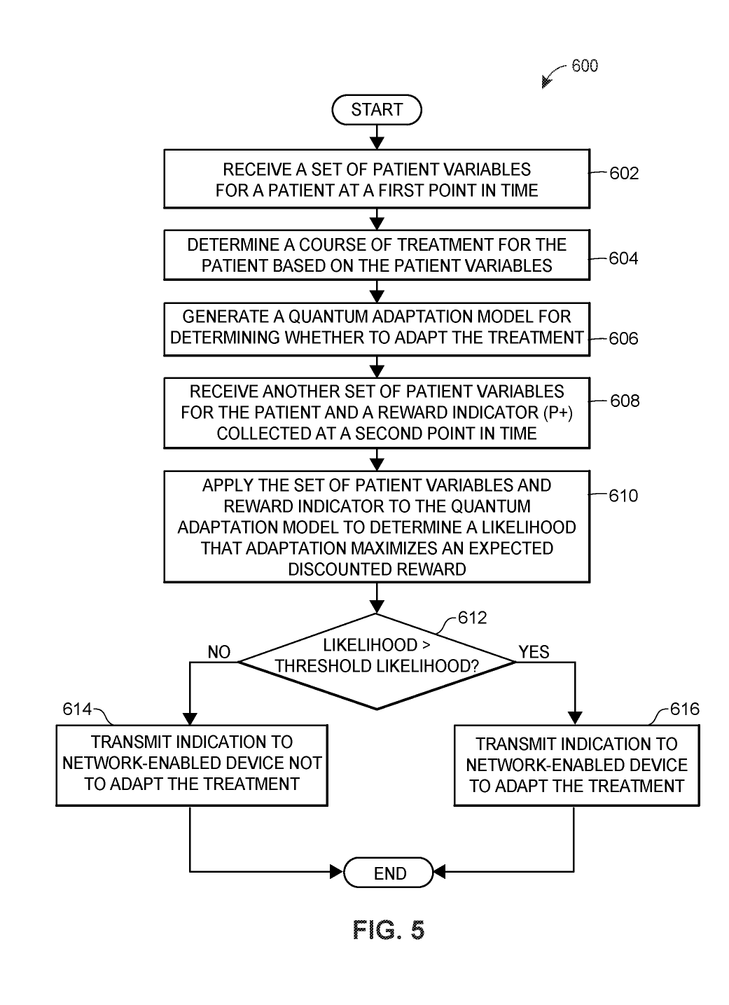

FIG. 5 illustrates a flow diagram of an example method 600 for adapting oncology treatment using quantum-based reinforcement learning techniques. The method 600 may be executed on the oncology treatment assessment server 140. In some embodiments, the method 600 may be implemented in a set of instructions stored on a non-transitory computer-readable memory and executable on one or more processors on the oncology treatment assessment server 140. For example, the method 600 may be performed by the quantum-based reinforcement learning engine 146 of FIG. 1.

At block 602, a set of patient variables is received for an oncology patient at a first point in time. The set of patient variables may include clinical variables, laboratory variables, biopsy variables, physical variables, biological variables, dosimetric variables, an indication of the severity of the patient's tumor, etc. The patient variables may be transmitted from a health care provider's network-enabled device. An optimal course of treatment is determined for the oncology patient to maximize an expected clinical outcome for the oncology patient based on the received set of patient variables (block 604).

For example, the oncology treatment assessment server 140 may obtain a set of training data by receiving clinical variables, laboratory variables, physical variables, biological variables, biopsy variables, etc. The training data may also include dosimetric variables indicating the course of treatment provided to the oncology patients and indications of clinical outcomes of the course of treatment, such as the severities of the oncology patients' tumors (P+). The oncology treatment assessment server 140 may generate a quantum model for predicting outcomes of various courses of treatment via a quantum analog to a machine learning algorithm, such as support vector machines or Bayesian networks using the training data. For example, while a classical model may be generated using graph kernels which compute an inner product on graphs, the quantum analog computes an inner product on qubits used to represent a superposition of the state variables from the training data.

The oncology treatment assessment server 140 may then compare the set of patient variables for the oncology patient to the quantum model and based on the comparison may determine the optimal course of treatment for the oncology patient. For example, the quantum model may be used to determine an expected clinical outcome (e.g., complication-free tumor control metric) for each of several possible courses of treatment. Then the course of treatment having the highest expected clinical outcome for the oncology patient may be selected. In other embodiments, the course of treatment for the patient may be determined using classical machine learning methods, such as support vector machines or Bayesian networks.

At block 606, the quantum-based reinforcement learning engine 146 may generate a quantum adaptation model for determining whether or not to adapt the selected course of treatment at second or subsequent points in time via a quantum analog to a reinforcement learning algorithm, such as MDP. The selected course of treatment may be adapted to a split-course treatment, fractions may be added to the selected course of treatment, or the selected course of treatment may be adapted in any other suitable manner. The decision to adapt the treatment or continue to provide the same treatment to the oncology patient may be represented by a qubit, |ψₐ>=α|Ã>+β|A>, where |A> is the action state to adapt the treatment, |Ã> is the action state not to adapt the treatment, and amplitudes α and β are complex numbers associated with the wave-like superposition. Amplitudes α and β also may be indicative of probabilities that the decision not to adapt or to adapt will provide the best expected clinical outcome or reward (P+).

The quantum adaptation model may be generated to identify a policy (π) (e.g., to adapt or not to adapt) which will maximize the total expected reward (V) for the oncology patient according to a particular state (s) (e.g., a combination of state variables and the clinical outcome (P+) at a subsequent point in time after receiving the course of treatment), where the total expected reward is discounted over time. The policy may be identified using the following equation:

V^{π}(s)=E{R|s,π},

where R is a return function.

The return function (R) may be determined based on individual expected rewards for each state (s) which are discounted over time. Using the qubit (|ψₐ>), the expected reward may be calculated over time by applying the time-dependent Schrödinger wave equation to the qubit which may be calculated as:

|ψₐ(t)>=e^{-Ht/h}|ψₐ>,

were H is a Hamiltonian. The Hamiltonian may be identified using quantum annealing and/or quantum adiabatic approaches. By using quantum annealing, the quantum-based machine learning engine 146 may escape local minima in the return function via quantum tunneling. By escaping local minima, the expected reward for a given point in time may be greater than 1 or less than 0 which is not possible in the classical world.

The resulting qubit at each point in time may be combined with the expected reward (P+) for the subsequent point in time, resulting in the following equation:

R=Σₜ₌₀^{∞}Pₜ₊₁⁺e^{-iHt/h}|ψₐ>,

where Pₜ₊₁⁺ is an expected reward for the subsequent point in time which may be different for the decision to adapt state (|A>) than the decision not to adapt state (|Ã>).

At block 608, the quantum-based reinforcement learning engine 146 may receive an updated set of patient variables for the oncology patient and an indication of a reward (P+) at a subsequent point in time after the first point in time. Using the quantum adaptation model and the state of the oncology patient according to the updated set of patient variables and reward, the quantum-based reinforcement learning engine 146 identifies the policy having the highest expected discounted reward (block 610). In some embodiments, using the qubit, |ψₐ(t)>, the quantum-based reinforcement learning engine 146 may determine likelihoods (|α|² and |β|²) that the action states |A> and |Ã> correspond to the highest expected discounted reward. The policy which maximizes the expected discounted reward may be identified using a quantum search algorithm, such as Grover's quantum search algorithm. For example, the policy may be to adapt the treatment to a split-course treatment or may be not to adapt the treatment.

In some embodiments, when the state of the system is unknown (e.g., at least some of the state variables are unknown or the reward (P+) is unknown at the subsequent point in time, such as the patient's tumor volume, weight loss, etc.), the quantum-based reinforcement learning engine uses a quantum analogue to a POMDP. The quantum analog is a superposition of all possible states or qubit (|ψ>), where each possible state has a corresponding action state which may be modeled by the qubit, |ψₐ> as mentioned above. In any event, the quantum-based reinforcement learning engine 146 may identify a particular policy (π) (e.g., to adapt or not to adapt) to maximize the expected reward discounted over time (V) at a particular state of the superposition of states. This policy may be identified using the following equation:

V^{π}(ρ)=E{R|ρ,π},

where R=trace(Σₜ₌₀^{∞} Pₜ₊₁⁺ρ) and ρ is a density matrix for pure states of the outer product |ψ><ψ|.

When the decision to adapt state |A> has a likelihood (|β|²) above a likelihood threshold (e.g., β|²>=0.5), the oncology treatment assessment server 140 may transmit an indication to a health care provider's network-enabled device to adapt the treatment for the oncology patient (block 616). Accordingly, the health care provider may administer the adapted treatment to the oncology patient. On the other hand, when the decision to adapt state |A> has a likelihood (|β|²) which does not exceed the likelihood threshold ((e.g., β|²<0.5), the oncology treatment assessment server 140 may transmit an indication to a health care provider's network-enabled device not to adapt the treatment for the oncology patient (block 614) or may not transmit any indication to the health care provider.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connects the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

This detailed description is to be construed as providing examples only and does not describe every possible embodiment, as describing every possible embodiment would be impractical, if not impossible. One could implement numerous alternate embodiments, using either current technology or technology developed after the filing date of this application.

We claim:

1. A method for adapting oncology treatment using quantum-based reinforcement learning, the method comprising:
receiving, at the one or more processors, a first set of patient data for an oncology patient including a plurality of patient variables collected at a first time;
determining, by the one or more processors, a course of treatment for the oncology patient based on the first set of patient data;
generating, by the one or more processors, a quantum adaptation model for determining whether to adapt the course of treatment, including representing a decision to adapt and a decision not to adapt the course of treatment as a superposition of quantum information states, wherein the decisions to adapt and not to adapt have associated likelihoods of improving a future clinical outcome for the oncology patient;
receiving, at the one or more processors, an updated set of patient data for the oncology patient collected at a subsequent point in time after the first time, including at least some of the plurality of patient variables or including an indication of a current clinical outcome of the course of treatment;
applying, by the one or more processors, the updated set of patient data to the quantum adaptation model to determine a likelihood that the decision to adapt improves the future clinical outcome; and
when the likelihood corresponding to the decision to adapt exceeds a threshold likelihood, transmitting, by the one or more processors, an indication to a network-enabled device of a health care provider to administer an adapted course of treatment to the oncology patient.

2. The method of claim 1, wherein the updated set of patient data for the oncology patient is represented as a state, the quantum adaptation model includes a plurality of states, and the quantum adaptation model is used to determine likelihoods that the decision to adapt and the decision not to adapt the course of treatment improves the future clinical outcome for the oncology patient according to a particular state of the plurality of states corresponding to the oncology patient.

3. The method of claim 2, wherein when at least one of the plurality of patient variables or the current clinical outcome of the course of treatment is not collected at the subsequent point in time, the state corresponding to the oncology patient is unknown and the method further includes:
generating, by the one or more processors, a second superposition of quantum information states, wherein each quantum information state within the second superposition represents a possible state of the oncology patient; and
determining, by the one or more processors, likelihoods that the decision to adapt and the decision not to adapt the course of treatment improves the future clinical outcome for the oncology patient according to the quantum adaptation model and the second superposition of quantum information states representing possible states of the oncology patient.

4. The method of claim 1, wherein determining a course of treatment for the oncology patient includes:
obtaining, at one or more processors, a set of training data including a plurality of patient variables associated with a plurality of oncology patients, a course of treatment applied to each oncology patient, and a current clinical outcome for each oncology patient;
generating, by the one or more processors, a quantum predictive model for determining a course of treatment of a plurality of courses of treatment for an oncology patient having a highest expected clinical outcome for the oncology patient; and
determining, by the one or more processors, the course of treatment of the plurality of courses of treatment having the highest expected clinical outcome for the oncology patient using the quantum predictive model.

5. The method of claim 1, wherein the current and future clinical outcomes are complication-free tumor control metrics.

6. The method of claim 5, wherein the complication-free tumor control metric is a product of a tumor control probability (TCP) and a normal tissues complications probability (NTCP).

7. The method of claim 6, wherein the likelihood for the decision to adapt is based on the TCP and NTCP for the oncology patient after receiving the course of treatment.

8. The method of claim 5, wherein the quantum adaptation model is generated by applying a time-dependent Schrödinger wave equation to the superposition of quantum information states to determine expected complication-free tumor control metrics discounted over time for the decision to adapt and the decision not to adapt.

9. The method of claim 1, wherein the likelihood that the decision to adapt improves the future clinical outcome is determined using a quantum search algorithm.

10. The method of claim 1, wherein the plurality of patient variables includes at least one of: clinical variables, biological variables, biopsy variables, physical variables, dosimetric variables, or laboratory variables.

11. A computing device for adapting oncology treatment using quantum-based reinforcement learning, the computing device comprising:
a communication network,
one or more processors; and
a non-transitory computer-readable memory coupled to the communication network and the one or more processors and storing thereon instructions that, when executed by the one or more processors, cause the computing device to:
receive, via the communication network, a first set of patient data for an oncology patient including a plurality of patient variables collected at a first time;
determine a course of treatment for the oncology patient based on the first set of patient data;
generate a quantum adaptation model for determining whether to adapt the course of treatment, including representing a decision to adapt and a decision not to adapt the course of treatment as a superposition of quantum information states, wherein the decisions to adapt and not to adapt have associated likelihoods of improving a future clinical outcome for the oncology patient;
receive, via the communication network, an updated set of patient data for the oncology patient collected at a subsequent point in time after the first time, including at least some of the plurality of patient variables or including an indication of a current clinical outcome of the course of treatment;
apply the updated set of patient data to the quantum adaptation model to determine a likelihood that the decision to adapt improves the future clinical outcome; and
when the likelihood corresponding to the decision to adapt exceeds a threshold likelihood, transmit, via the communication network, an indication to a network-enabled device of a health care provider to administer an adapted course of treatment to the oncology patient.

12. The computing device of claim 11, wherein the updated set of patient data for the oncology patient is represented as a state, the quantum adaptation model includes a plurality of states, and the quantum adaptation model is used to determine likelihoods that the decision to adapt and the decision not to adapt the course of treatment improves the future clinical outcome for the oncology patient according to a particular state of the plurality of states corresponding to the oncology patient.

13. The computing device of claim 12, wherein when at least one of the plurality of patient variables or the current clinical outcome of the course of treatment is not collected at the subsequent point in time, the state corresponding to the oncology patient is unknown and the instructions further cause the computing device to:
generate a second superposition of quantum information states, wherein each quantum information state within the second superposition represents a possible state of the oncology patient; and
determine likelihoods that the decision to adapt and the decision not to adapt the course of treatment improves the future clinical outcome for the oncology patient according to the quantum adaptation model and the second superposition of quantum information states representing possible states of the oncology patient.

14. The computing device of claim 11, wherein to determining a course of treatment for the oncology patient, the instructions cause the computing device to:
obtain a set of training data including a plurality of patient variables associated with a plurality of oncology patients, a course of treatment applied to each oncology patient, and a current clinical outcome for each oncology patient;
generate a quantum predictive model for determining a course of treatment of a plurality of courses of treatment for an oncology patient having a highest expected clinical outcome for the oncology patient; and
determine the course of treatment of the plurality of courses of treatment having the highest expected clinical outcome for the oncology patient using the quantum predictive model.

15. The computing device of claim 11, wherein the current and future clinical outcomes are complication-free tumor control metrics.

16. The computing device of claim 15, wherein the complication-free tumor control metric is a product of a tumor control probability (TCP) and a normal tissues complications probability (NTCP).

17. The computing device of claim 16, wherein the likelihood for the decision to adapt is based on the TCP and NTCP for the oncology patient after receiving the course of treatment.

18. The computing device of claim 15, wherein the quantum adaptation model is generated by applying a time-dependent Schrödinger wave equation to the superposition of quantum information states to determine expected complication-free tumor control metrics discounted over time for the decision to adapt and the decision not to adapt.

19. The computing device of claim 11, wherein the likelihood that the decision to adapt improves the future clinical outcome is determined using a quantum search algorithm.

20. The computing device of claim 11, wherein the plurality of patient variables includes at least one of: clinical variables, biological variables, biopsy variables, physical variables, dosimetric variables, or laboratory variables.
